(19) United States
(12) Patent Application Publication
(10) Pub. No.: US 2004/0116571 A1
(43) Pub. Date: Jun. 17, 2004

(54) Thermally conductive thermoplastic materials and method of making the same

(76) Inventors: Yung-Ming Su, Changhua City (TW); Chin-Huei Yen, Tao-Yuan City (TW)

Correspondence Address: SUPREME PATENT SERVICES, POST OFFICE BOX 2339, SARATOGA, CA, 95070, US

(21) Appl. No.: 10/318,631

(22) Filed: Dec. 12, 2002

(51) Int. Cl. C08K 3/38

(52) U.S. Cl. 524/404; 524/432; 524/437; 523/353

(57) ABSTRACT

A heat transfer material includes thermoplastic elastomer such as styrenic block copolymer, oil and fillers, and has a composite heat transfer coefficient greater than 0.8 watts/m-K. The material is easily conformable to irregularly shaped surfaces and has low thermal impedance values less than 0.1K-in²/W at 0.5 MPa mounting pressure. The material has a good dry-out performance of less than 0.15% at 70° C., 240 hours, which are better than the existing thermal conductive grease. More particularly, the material has excellent re-usability.

### FIELD OF THE INVENTION

This invention relates to thermally conductive materials and articles and methods of use thereof.

### BACKGROUND OF THE INVENTION

It is important to conduct heat from circuit boards and components to a metal plate or cooling devices that can then remove the heat from the electrical devices. Various methods have been used to enhance the conduction of heat between solid surfaces. Thermally conductive elastomers, which typically have a Shore A durometer hardness in the range above 40, are relatively hard and lack conformability for irregularly shaped substrates, such as printed circuit boards containing CPU (Central Processing Unit), transistors, resistors, diodes and other electrical components thereon. Therefore, such elastomers typically are not suitable for heat conduction path for the removal of heat for certain critical electronic components.

Thermally conductive greases and pastes are also known to enhance heat transfer. However, such greases and pastes have disadvantages of migrating into unwanted areas, dry-out over time and pump-out through power cycling, thus contaminating other areas of the device and causing loss of thermal conductivity, and becoming very difficult to handle and clean-up when reentering the electrical device for upgrade or replacement. Thermal grease-based materials are recommended for applications at lower operating temperatures (to alleviate phase separation), lower die loading (to alleviate mechanical damage), and lower power cycling requirements (to alleviate pump-out).

Phase change material (PCM) is also recommended for thermal conductive purposes. Since it becomes rigid after cooling down, it might damage some fragile devices because of mechanical shock. Besides, it is even more difficult to handle or clean up than the thermal grease when repairing or replacement is needed.

All the materials and application methods currently used for thermal conductive purposes require skillful workers or good attention to have excellent performance without getting messy. Besides, none of them can be reclaimed and reused easily.

U.S. Pat. No. 4,852,646 shows a gel obtained from vinyl terminated polydimethylsiloxane and a hydride functionalized polydimethylsiloxane, which merely describes and claims the limitations of the cone penetration, elongation; a particulate filler get from Dow chemical (aluminum nitride) . . . etc. By the above mentioned patent, the users still can not get good thermal conductivity without getting messy.

U.S. Pat. No. 5,929,138 shows the gel can obtained from styrene-(ethylene butylenes)-styrene or styrene-(ethylene propylene)-styrene block copolymer and specific filler (alpha-alumina). Although it has better thermal conductivity, it cannot be reused and may get messy too.

Therefore, in order to overcome the above-mentioned defects, there is a need to develop new methods to solve the problem.

### SUMMARY OF THE INVENTION

The invention relates to developing a thermally conductive thermoplastic material with low thermal impedance, good stability, low dry-out, less risk of mechanical shock, easy-applying and reusable.

It is another object of the present invention to provide a new way for the users to apply the material easily and neatly without skillful technicians and messy operation site.

It is another object of the present invention to provide a new thermally conductive thermoplastic material that are elastomeric material so that the users do not worry about mechanical shock that might happen when phase change material (PCM) is used for thermal conductive purpose.

It is another object of the present invention to provide a new thermally conductive thermoplastic material that can be recycled and reused barehanded and with almost no loss of performances.

In one aspect, the present invention provides a thermally conductive thermoplastic material comprising a styrenic block copolymer, wherein the amount of the styrenic block copolymer is approximately from 0.8% to 10% by weight of the thermally conductive thermoplastic material; an oil, wherein the amount of the oil is approximately from 10% to 30% by weight of the thermally conductive thermoplastic material; a filler, wherein the amount of the filler is approximately from 80% to 90% by weight of the thermally conductive thermoplastic material and more than about 90% of the particle size of said filler is about from 1 μm to 40 μm; a coupling agent, which is maleic anhydride grafted PP, EPDM, SEBS and SEPS, however, it can also be silanes, titanates, zirconium aluminates and the mixtures of the these materials (including the above mentioned maleic anhydride grafted polymers), wherein the amount of said coupling agent is about 0.3% to 2.0% by weight of the thermal conductive thermoplastic material.

In another aspect, this invention provides a method to enhance the performance of heat transfer in electrical devices comprising; firstly, applying a sufficient amount of the thermally conductive thermoplastic material to a substrate from which or to which heat is to be transferred; secondly, providing a desired pressure to the thermally conductive thermoplastic material to ensure good contact between the thermally conductive thermoplastic composition and the hard substrate; thirdly, providing a second substrate to the exposed surface of the thermally conductive thermoplastic material from which or to which heat is to be transferred; and providing a desired pressure to the thermally conductive thermoplastic material between the two substrates to obtain the desired heat transfer. The pressure applied is preferably greater than 0.2 MPa to ensure closely contact ability between the thermally conductive thermoplastic material and the hard substrate. By this simple method, the users can use the thermally conductive material to conduct heart to the air without too much skill and at no risk of getting messy.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein

FIG. 1 is a sketch view for showing the compressibility of example 1, 2 and 3;

FIG. 2 is a sketch view for showing the thermal impedance of example 1, 2 and 3;

FIG. 3 is a sketch view for showing the dry out test at 70° C. for example 1, 2 and 3 and compared with conventional product;

FIG. 4 is a sketch view for showing the reusability of the example 2;

FIG. 5 is a sketch view for showing the pressure vs. thickness of example 2;

FIG. 6 is a sketch view of dummy heater; and

Table 1 shows the thermal impedance and thermal conductivity and compositions of each example.

### DETAILED DESCRIPTION OF THE INVENTION

Some embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

The thermally conductive thermoplastic material of the present invention comprises:

A. A thermoplastic elastomer (TPE), which may be styrenic block copolymer with mid-block and end-block constitution, the mid-block may be ethylene-butylene or ethylene-propylene and the end-block may be polystyrene (i.e. SEBS, SEPS, SEB, and SEP) and mixtures, wherein the TPE is present in an amount between about 0.8% and about 10% by weight of the material;

B. An oil having viscosity between about 5 and 250 cst at 40° C., wherein the oil is present in an amount between about 10% and about 30% by weight of the composition;

C. A filler having a thermal conductivity of about 20 watts/m-K at least, wherein the filler is selected from the group consisting of aluminum oxide, aluminum hydroxide, aluminum nitride, and boron nitride, and more than about 90% of the filler is of particle size between about 1 μm and about 40 μm; wherein the filler is present in an amount between about 80% and 90% by weight; and

D. A coupling agents, which is maleic anhydride grafted PP, EPDM, SEBS, and SEPS, however, it can also be silanes, titanates, zirconium aluminates and the mixtures of these material (including the above mentioned maleic anhydride grafted polymers), wherein the coupling agents is present in an amount between 0.3% and 2.0% by weight of the material.

The material used in the present invention may be any composition or material having high conformability as well as sufficient mechanical strength. Such material may be styrenic block copolymers and other compositions which provide properties necessary for the composition with high conformability under low compression forces to provide the good surface contact and adhesion to the surfaces between which the thermally conductive materials of this invention is placed or compressed.

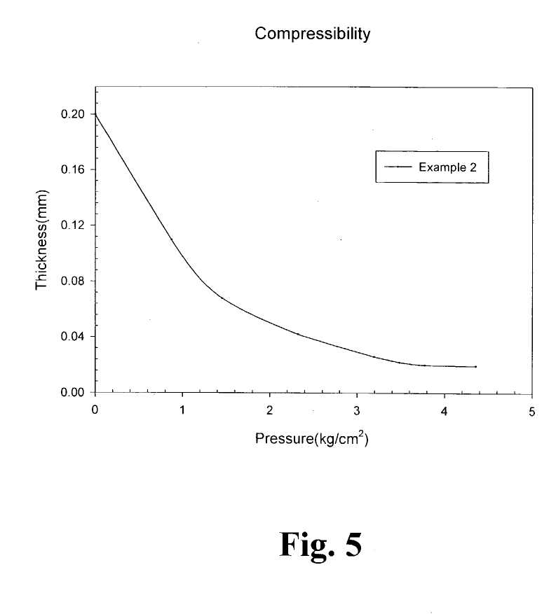

In general, the material used in the present invention have Shore A hardness from about 0 to about 40. In many applications, it is preferred that the material has a hardness between about Shore A 0 and 20. The thermally conductively material has very good conformability that the thickness can reach 0.05 mm and below from 2 mm original at 0.5 MPa (as shown in FIG. 5).

The particulate filler material used in the present invention can be any particulate type material which can be dispersed uniformly with the TPE composition providing a composition having a thermal impedance of less than about 0.1K-in²/watt at a mounting pressure of 0.5 MPa.

The particulate filler material can be of any physical shape and desired form to provide the above thermal impedance values of the TPE composition. For example, the particulate filler may be powders of varying particle sizes and the particles may be of any desired shape such as round, irregular, flake and platelet type particles.

When combined with the TPE composition described above, the particulate filler used in the present invention may be conventional thermally conductive filler, which provides a composition having the properties set forth above. Particularly preferred are those conductive materials that have a thermal conductivity greater than about 20 watts/m-K, such as aluminum nitride, boron nitride, aluminum oxide, aluminum hydroxide and zinc oxide.

The particulate filler used in the present invention may be electrically insulators, such as examples mentioned above or may be electrically conductive like metal or graphite. And the particulate filler described herein can be used in various mixtures to provide the desired properties by following the TPE composition of the present invention.

The particulate filler can constitute more than 80% and up to about 90% by weight of the thermally conductive thermoplastic material composition, preferably about 80% to about 88% by weight of the composition. It should be noted that when the particulate filler are combined with the TPE mentioned above, it has sufficient mechanical properties. However, it is important to note that the thermally conductive thermoplastic material composition has a hardness of Shore A 0-40, preferably 0-20, to provide the desired conformability to the various surfaces and substrates on which the composition of this invention is applied. It has been found surprisingly that the TPE materials can be loaded with such high proportions of particulate filler and still maintain sufficient mechanical properties and conformability. The smaller particle size used in this invention can have better mechanical properties as well as chance for the conductive filler to fill in the pocket on the surface of the hard substrate.

The high oil/thermally conductive thermoplastic material ratio used in this invention ensures that the thermal conductive thermoplastic composition has good conformability even with such high filler loading. A composition with higher loading of thermal conductive filler and good conformability are the most critical conditions to have good performance for thermal interfacial material applications.

The thermally conductive thermoplastic material composition of this invention may be used in combination with a carrier strip or matrix to support the composition as well. The support material may be any matrix material, such as woven and non-woven fabrics, or the like. In order to use a support structure for the composition of this invention, it is necessary that such a structure or material is capable of being melt-coated with the thermally conductive thermoplastic material composition and that the support material is sufficiently flexible so as not to interfere with the conformability of the compositions of this invention.

The support matrix material can also be selected to have a high thermal conductivity thereby not interfering with or detracting from the desirable thermal conductivity properties of the material of the present invention. However, using a low thermal conductivity material lowers the performance while a high thermal conductivity material enhances overall performance. For example, a woven fabric of graphite fibers provides enhanced thermal conductivity in the present invention. When a support matrix, such as a fabric, is used, it is preferred that the support matrix material has a minimum thermal conductivity of at least 2 watts/m-K, more preferably greater than about 10 watts/m-K. Since thermal impedance is sensitive to the pressure at which the conductive material is mounted on the test surface, thermal impedance values are given at specified mounting pressures ranging from zero to about 0.5 MPa or greater. Thermally conductive elastomeric materials that conventionally known are typically characterized in terms of thermal impedance at a mounting pressure between about 2 MPa and about 4 MPa. This has been necessary because the hardness of the conventional elastomeric materials which require higher compressive mounting forces to obtain good surface contact ability and conformability between the thermally conductive material and the substrate surface. While the material of the present invention are equally useful at mounting pressures such as 0.2 MPa and above, where they provide lower thermal impedance than prior art materials do, the compositions and materials of the present invention are also particularly useful at low mounting pressures and exhibit low thermal impedance. This capability of the present invention makes them particularly useful not only in conventional applications but also in thermal contact with delicate electronic components which cannot physically withstand the forces involved in higher mounting pressures. The thermal impedance values are obtained by testing a sample material, which has a thickness of about 0.1 mm to about 0.2 mm. For example, the test data in this application was obtained using test samples which were 0.1 mm to 0.2 mm in thickness.

### EXAMPLE 1

Premixing SEBS (styrene-ethylene-butylene-styrene block copolymer) (Kraton G1651 from Kraton Polymers) 100 grams with mineral oil (from PetroUltra Oils) 700 grams and allowing the polymer to swell for hours. Blending 18 grams of the premixed composition with filler (AM-21 from Sumitomo Chemical) 82 grams and other additives (e.g. antioxidants 0.1 grams). Placing the mixture in a mixer (e.g. Brabander mixer), and thereafter, fluxing the mixture at 140° C. for 20 minutes. To improve the mechanical properties of the mixture, a coupling agent may be added. The filler can be treated with the coupling agent beforehand, or after the coupling agent being added to the polymer phase. Coupling agents, such as maleic anhydride grafted polymers, and silanes, titanates, zirconium aluminates and the mixtures thereof are commonly used.

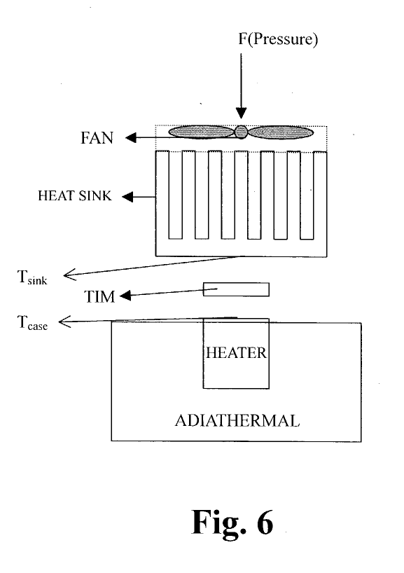

The thermal impedance test is conducted in a dummy heater (as shown in FIG. 6), which generates constant heat flow by electrical heating, and the heat is taken away through a heat sink. Temperature differences are measured and the thermal impedance is calculated by the following equations:

R_{ca}=ΔT*A/P

where ΔT is temperature difference between die and environment, A is contact area die and the thermal interface material and P is power input.

TABLE 1
Results of examples

| | | | | Thermal | Thermal |
|---|---|---|---|---|---|
| | | | | Conductivity | impedance |
| | TPE % | Alumina % | Oil % | (W/m-K) | (K-in²/W) |
| Example 1 | 2.25 | 82 | 15.75 | 1.3 | 0.14 |
| Example 2 | 1.13 | 83.02 | 15.85 | 1.3 | 0.02 |
| Example 3 | 1.13 | 83.11 | 15.76 | 1.4 | 0.08 |

### EXAMPLE 2

Premixing SEBS (styrene-ethylene-butylene-styrene block copolymer) (Kraton G1651 from Kraton Polymers) 10 grams with mineral oil (from PetroUltra Oils) 140 grams. Allowing the polymer to swell for hours. Blending 17 grams of the premixed composition with filler (AM-21 from Sumitomo Chemical) 83 grams and other additives (e.g. antioxidants 0.1 grams). Placing the mixture in a mixer (e.g. Brabander mixer). Thereafter, fluxing the mixture at 110° C. for 20 minutes.

To improve the mechanical properties of the mixture, a coupling agent may be added. The filler can be treated with the coupling agent beforehand, or after the coupling agent being added to the polymer phase. Coupling agents, such as maleic anhydride grafted polymers, and silanes, titanates, zirconium aluminates and the mixtures thereof are commonly used.

### EXAMPLE 3

Premixing SEBS (styrene-ethylene-butylene-styrene block copolymer) (Kraton G1651 from Kraton Polymers) 10 grams with synthetic oil (from Solutia) 140 grams. Allowing the polymer to swell for hours. Blending 17 grams of the premixed composition with filler (AM-21 from Sumitomo Chemical) 83 grams and other additives (e.g. antioxidants 0.1 gms). Placing the mixture in a mixer (e.g. Brabander mixer). Thereafter, fluxing the mixture at 110° C. for 20 minutes.

To improve the mechanical properties of the mixture, a coupling agent may be added. The filler can be treated with the coupling agent beforehand, or after the coupling agent being added to the polymer phase. Coupling agents, such as maleic anhydride grafted polymers, and silanes, titanates, zirconium aluminates and the mixtures thereof are commonly used.

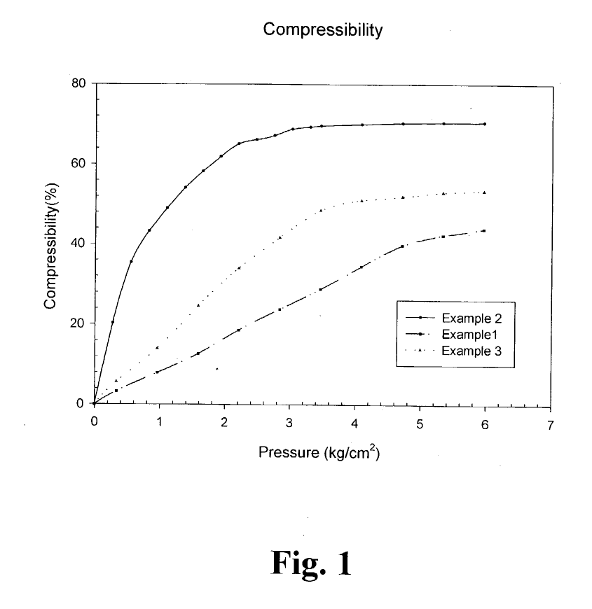

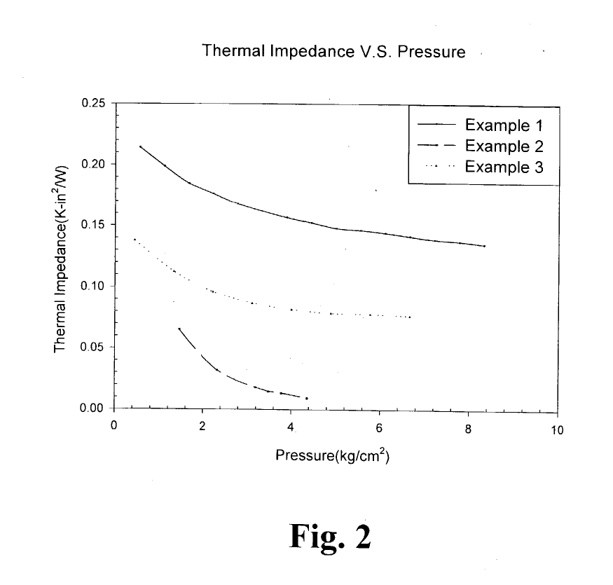

Referring to FIGS. 1 and 2, it shows that examples of the present invention have good thermal impedance and compressibility.

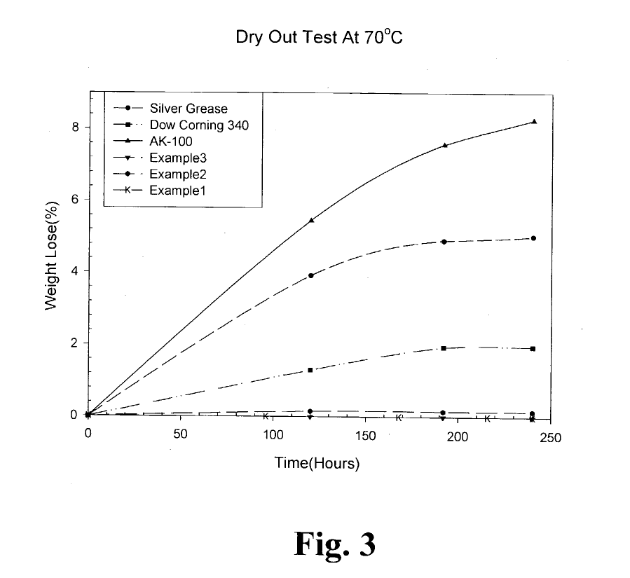

Referring to FIG. 3, compared with the conventional products, examples 1, 2 and 3 show better dry-out performance than the prior art has.

Since the thermally conductive thermoplastic material is thermoplastic, the material can be re-used by heating through various methods, such as hot press, lamination, coating and screen printing. For example:

A. Applying a sufficient amount of the flexible thermally conductive thermoplastic composition;

B. When replacement of the devices or the heat sinks is required, the material can be recycled and reused barehanded; and

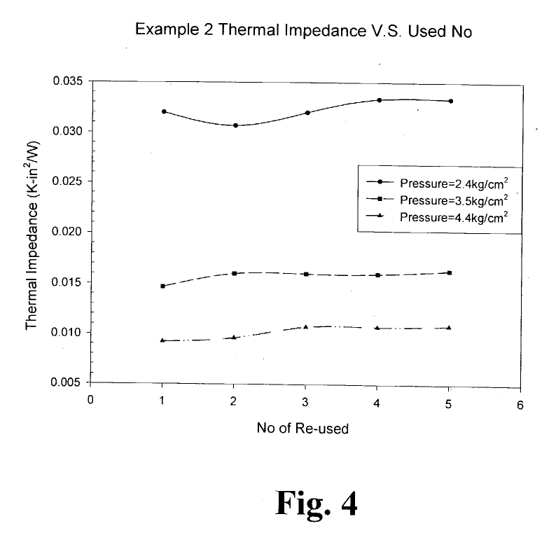

C. The material can be reused for at least 5 times with almost no loss of performance (as shown in FIG. 4).

With this ideal flexible thermally conductive thermoplastic material mentioned above, the users can easily replace devices by using the same piece of thermal interfacial material.

Referring to FIG. 4, we can see that all of the example can be reused bareheaded and at least.

Referring to FIG. 5, we can see that the thickness of the thermally conductively material (example 2) can reach 0.05 mm and below from 2 mm original at 0.5 Mpa, which proves the thermally conductively material indeed has very good conformability.

What is claimed is:

1. A thermally conductive thermoplastic material comprising:
a styrenic block copolymer, having mid-block and end-block constitution, wherein the amount of said styrenic block copolymer is about from 0.8% to 1% by weight of said thermally conductive thermoplastic material;
an oil having viscosity between 5 cst. and 250 cst. at 40° C., wherein the amount of said oil is about from 10% to 30% by weight of said thermally conductive thermoplastic material;
a filler with thermal conductivity of at least about 20 watts/m-K, wherein the amount of said filler is about from 80% to 90% by weight of said thermally conductive thermoplastic material; and
a coupling agent, wherein the amount of said coupling agent is about 0.3% to 2.0% by weight of said thermally conductive thermoplastic material.

2. The material according to claim 1, wherein the mid-block of said styrenic block copolymer is selected from at least one of the group of ethylene-butylene, ethylene-propylene and the like; and the end-block is polystyrene.

3. The material according to claim 1, wherein said oil is selected from one of mineral oil, synthetic oil and the mixtures thereof.

4. The material according to claim 1, wherein said filler is electrically insulative.

5. The material according to claim 4, wherein more than 90% of the particle size of said filler is approximately from 1 μm to 40 μm.

6. The material according to claim 5, wherein the material of said filler is selected from at least one of the group of aluminum oxide, aluminum hydroxides, aluminum nitride, zinc oxide and boron nitride.

7. The material according to claim 1, wherein said coupling agent is maleic anhydride grafted with at least one of the group of PP, EPDM, SEBS and SEPS.

8. The material according to claim 1, wherein said coupling is selected from at least one of the group of silanes, titanates and zirconium aluminates.

9. A thermally conductive thermoplastic material comprising:
a styrene-ethylene-butylene-styrene (SEBS) block copolymer, wherein the amount of said block copolymer is about from 0.8% to 10% by weight of said thermally conductive thermoplastic material;
a mineral oil, wherein the amount of said mineral oil is about from 10% to 30% by weight of said thermally conductive thermoplastic material;
a filler, wherein the amount of said filler is about from 80% to 90% by weight of said thermally conductive thermoplastic material;
a coupling agent, which is maleic anhydride grafted polymers, wherein the amount of said coupling agent is about 0.3% to 2.0% by weight of said thermally conductive thermoplastic material.

10. The material according to claim 9, wherein more than 90% of the particle size of said filler is about 1 μm to 40 μm.

11. The material according to claim 9, wherein said maleic anhydride is grafted with at least one of the group of PP, EPDM, SEBS and SEPS.

12. The material according to claim 9, wherein said coupling agent is selected from at least one of the group of silanes, titanates and zirconium aluminates.

13. A method of making a thermally conductive thermoplastic material, comprising the following steps:
(a) providing a styrenic copolymer having mid-block and end-block constitution, wherein the amount of said styrenic block copolymer is about from 0.8% to 10% by weight of said thermal conductive thermoplastic material;
(b) premixing said styrenic block copolymer with an oil having viscosity between 5 cst. and 250 cst. at 40° C. to form a combination, wherein the amount of said oil is about from 10% to 30% by weight of said thermally conductive thermoplastic material;
(c) blending said combination with a filler having thermal conductivity of at least about 20 watts/m-K to form a mixture, wherein the amount of said filler is about from 80% to 90% by weight of said thermally conductive thermoplastic material;
(d) fluxing the mixture at about 50° C. to 200° C.; and
(e) adding a coupling agent, which mainly consists of maleic anhydride grafted polymers, wherein the amount of said coupling agent is about 0.3% to 2.0% by weight of said thermal conductive thermoplastic material.

14. The method according to claim 13, wherein the mid-block of said styrenic block copolymer is selected from at least one of the group of ethylene-butylene, ethylene-propylene and the like; and the end-block is polystyrene.

15. The method according to claim 13, wherein said oil is selected from one of mineral oil, synthetic oil and the mixtures thereof.

16. The method according to claim 13, wherein said filler is electrically insulative.

17. The method according to claim 16, wherein more than about 90% of the particle size of said filler is about 1 μm to 40 μm.

18. The method according to claim 17, wherein the material of said filler is selected from at least one of the group of aluminum oxide, aluminum hydroxides, aluminum nitride, zinc oxide and boron nitride.

19. The method according to claim 13, wherein said maleic anhydride is grafted with at least one of the group of PP, EPDM, SEBS and SEPS.

20. The method according to claim 13, wherein said coupling agent is selected from at least one of the group of silanes, titanates and zirconium aluminates.
